(19) United States
(12) Patent Application Publication
(10) Pub. No.: US 2020/0084959 A1
(43) Pub. Date: Mar. 19, 2020

(54) CONTROLLED-RELEASED FERTILISER CONTAINER

(71) Applicant: PLANTSAFE GLOBAL SDN. BHD., Shah Alam (MY)

(72) Inventor: Kim Fui NG, Shah Alam (MY)

(21) Appl. No.: 16/470,342

(22) PCT Filed: Feb. 28, 2018
(86) PCT No.: PCT/MY2018/050009

§ 371 Date: Jun. 17, 2019

(30) Foreign Application Priority Data
Mar. 1, 2017 (MY) PI 2017700706

(51) Int. Cl. A01C 23/00; A01C 23/02; A01G 29/00

(52) U.S. Cl. CPC A01C 23/007; A01G 29/00; A01C 23/008; A01C 23/027

(57) ABSTRACT

A container for controlling release of a soluble fertiliser comprising a first chamber for collecting and holding water, and having an open top and a solid bottom with an orifice that allows water flow freely at a desired rate; a second chamber below the first chamber for receiving water therefrom to dissolve fertiliser held therein, the second chamber having a solid bottom with an orifice through which fertiliser solution can flow in a controlled manner and a perforated plate for holding undissolved fertiliser, the plate is disposed within the chamber and separating the chamber into an upper compartment and a lower compartment; and a third chamber below the second chamber and receiving dissolved fertiliser therefrom, the third chamber having a perforated bottom, the perforations are configured to allow the dissolved fertiliser to pass through while preventing foreign solid particles from entering the container.

### FIELD OF INVENTION

This invention relates to a plant feeding device. More particularly, the present invention relates to a container for holding fertiliser, wherein the container is configured to control the release of the fertiliser therein to a plant.

### BACKGROUND OF INVENTION

Periodically, fertiliser is required to be applied to soil for supplying or replenishing one or more nutrients essential to plant growth. To save labour or machinery cost, there may be attempts to minimise the number of time required to reapply the fertiliser. For example, a larger amount of fertiliser is applied at one time or intentionally prolong the period of reapplying fertiliser. However, this may cause the problems of over-fertilisation or under-fertilisation. In case of over-fertilisation, this may cause the soil condition not conducive to plant growth. On the other hand, under-fertilisation may eventually cause the plant to wither and die unless measures are taken to combat these conditions.

To overcome the aforementioned problems, slow- or controlled-released fertiliser has been developed so that nutrients can be released to the soil gradually over a period of time. Controlled-release fertiliser is usually in the form of granules which may contain insoluble substrate or a semi-permeable jacket that prevents dissolution while allowing nutrients to flow outward. Despite the controlled-release technology is rather matured in the art, the use thereof merely occupies a small portion of the industry. This is because such fertiliser is still prone to be swept away before its nutrients are completely released, especially during raining season. In long term, the use of controlled-release fertiliser to some extend still does not reduce much on the time required for reapplying fertiliser as well as solving the abovementioned problems.

Another attempt has been done to achieve controlled-release of fertiliser while the fertiliser is not prone to be swept away. One example is disclosed in U.S. Pat. No. 3,757,469. A device for irrigating and feeding plants is disclosed, the device has a reservoir for holding water, a controlled flow seepage device, and a fluid conductor connected between the reservoir and the seepage device for conducting the water in the reservoir to the seepage device, wherein the seepage device may contain material of high moisture retention qualities and a soluble fertilising agent for feeding the plant. When in use, the device is adapted for use under lawns or other low ground cover plants. Nevertheless, the installation of such device in large scale for every plant is inconvenient as the conduit needs to be placed around the roots of each plant so that it can function properly. Further, maintenance of such device and replenishing of the water retentive material are difficult especially in large plantation.

To overcome the drawbacks of the existing technology, it is desirable to invent an improved device for releasing fertiliser in a controlled manner which is easy to install, durable, and easy to maintain.

This invention provides a solution to the problems.

### SUMMARY OF INVENTION

One of the objects of the invention is to provide a container for holding a soluble fertiliser and releasing dissolved fertiliser in a controlled manner which is more cost effective.

At least one of the preceding aspects is met, in whole or in part, by the present invention, in which the embodiment of the present invention describes a container for controlling release of a soluble fertiliser comprising a first chamber for collecting and holding water, and having an open top and a solid bottom with an orifice that allows water flow freely at a desired rate; a second chamber below the first chamber for receiving water therefrom to dissolve fertiliser held therein, the second chamber having a solid bottom with an orifice through which fertiliser solution can flow in a controlled manner and a perforated plate for holding undissolved fertiliser, the plate is disposed within the chamber and separating the chamber into an upper compartment and a lower compartment; and a third chamber below the second chamber and receiving dissolved fertiliser therefrom, the third chamber having a perforated bottom, the perforations are configured to allow the dissolved fertiliser to pass through while preventing foreign solid particles from entering the container.

In a preferred embodiment of the invention, the chambers are detachable and stacking one on top of the other to allow refilling of the soluble fertiliser as well as flexibility in achieving a different flow rate through each orifice.

Preferably, a perforated cover is provided over the first chamber, in which the perforations are sized to prevent foreign solid particles from entering the container while allowing water to pass through.

In another preferred embodiment of the invention, the flow rate through the orifices is configured according to the formula Q=C_{d}A\sqrt{2gh}, in which Q is liquid flow rate through the orifice, C_{d} is coefficient of discharge, A is effective surface area of the orifice, g is gravitational force, and h is height of the liquid in the chamber. Preferably, the cross-section of the orifices is trapezoidal, circular, square, or rectangular.

Still in another preferred embodiment of the invention, a means for anchoring the container in ground is provided.

The preferred embodiment of the invention consists of novel features and a combination of parts hereinafter fully described and illustrated in the accompanying drawings and particularly pointed out in the appended claims; it being understood that various changes in the details may be effected by those skilled in the arts but without departing from the scope of the invention or sacrificing any of the advantages of the present invention.

### BRIEF DESCRIPTION OF THE DRAWINGS

For the purpose of facilitating an understanding of the invention, there is illustrated in the accompanying drawing the preferred embodiments from an inspection of which when considered in connection with the following description, the invention, its construction and operation and many of its advantages would be readily understood and appreciated.

FIG. 1 is a perspective view of the container as embodied by one of the preferred embodiments of the invention.

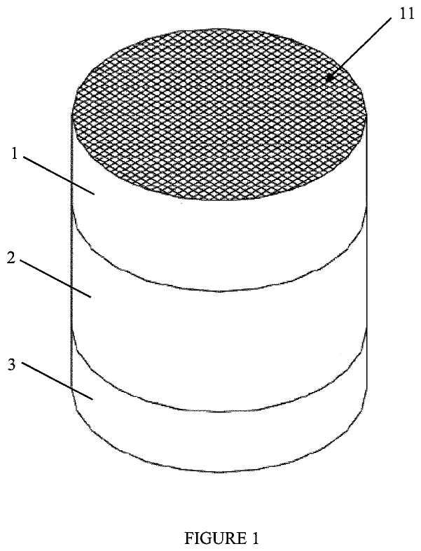

FIG. 2 is an exploded perspective view of the container as embodied by one of the preferred embodiments of the invention.

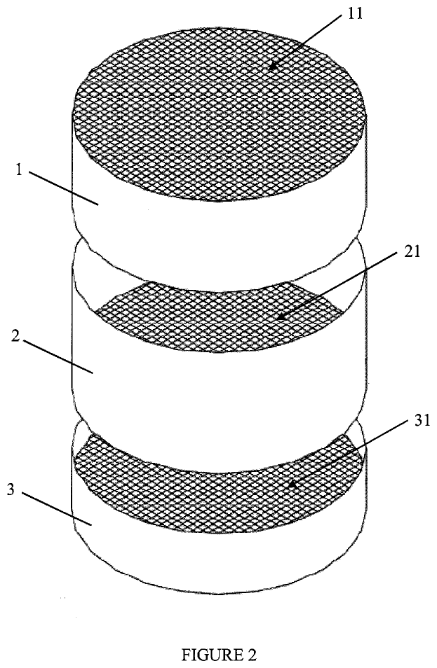

FIG. 3 is an exploded see-through perspective view of the container as embodied by one of the preferred embodiments of the invention.

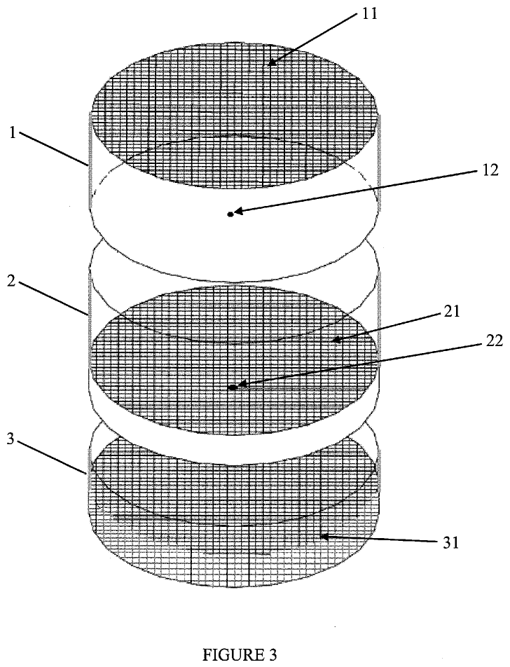

### DETAILED DESCRIPTION OF THE INVENTION

This invention relates to a plant feeding device. More particularly, the present invention relates to a container for holding fertiliser, wherein the container is configured to control the release of the fertiliser therein to a plant.

Hereinafter, the invention shall be described according to the preferred embodiments of the present invention and by referring to the accompanying description and drawings. However, it is to be understood that limiting the description to the preferred embodiments of the invention and to the drawings is merely to facilitate discussion of the present invention and it is envisioned that those skilled in the art may devise various modifications without departing from the scope of the appended claim.

The invention discloses a container for controlling release of a soluble fertiliser comprising a first chamber (1) for collecting and holding water, and having an open top and a solid bottom with an orifice (12) that allows water flow freely at a desired rate; a second chamber (2) below the first chamber (1) for receiving water therefrom to dissolve fertiliser held therein, the second chamber (2) having a solid bottom with an orifice (22) through which fertiliser solution can flow in a controlled manner and a perforated plate (21) for holding undissolved fertiliser, the plate (21) is disposed within the chamber (2) and separating the chamber (2) into an upper compartment and a lower compartment; and a third chamber (3) below the second chamber (2) and receiving dissolved fertiliser therefrom, the third chamber (3) having a perforated bottom (31), the perforations are configured to allow the dissolved fertiliser to pass through while preventing foreign solid particles from entering the container.

In general, the container may be configured in any shape and size and made from any material. For the purpose of illustration, the container in the following description will be described as a cylindrical container, with reference to the accompanying drawings. Preferably, the container comprises three chambers (1, 2, 3), one on top of the other, each serves for different purposes and works together to provide the container the capability of controlling release of a soluble fertiliser. The topmost chamber (1), hereinafter referring to a first chamber (1), serves to collect and hold water which flows freely at a desired rate to the chamber (2) therebelow, hereinafter referring to a second chamber (2). The second chamber (2) serves to hold a pre-filled amount of soluble fertiliser which dissolves upon contact with a sufficient amount of overflow water. Likewise, the fertiliser solution flows at a controlled manner to the bottommost chamber (3), hereinafter referring to a third chamber (3), and is released to the surrounding medium from the third chamber (3).

In one embodiment of the invention, the container has a top that is opened for receiving water, particularly rainwater. This is to ensure that the first chamber (1) always have enough water to dissolve the fertiliser in the second chamber (2). However, it is preferable to provide the container with a perforated cover (11) to prevent large foreign solid particles from entering the container while allowing water to pass through. The first chamber (1) has a solid bottom with an orifice (12) through which water is passed through and flowed to the second chamber (2). With the presence of the perforated cover (11), the risk of obstruction on the orifice (12) by solid particles can be minimised. The orifice (12) can be positioned on any spot of the bottom but preferably towards the centre of the bottom. It is important to carefully configure the orifice (12) so that water is allowed to flow through, in a controlled manner, at a desired rate.

The second chamber (2) has a solid bottom with an orifice (22) through which water is passed through and flowed to the third chamber. (3) According to the preferred embodiment of the invention, a perforated plate (21) is disposed within, and across, the second chamber (2) thereby separating the second chamber (2) into two portions: an upper compartment and a lower compartment. The upper compartment holds the soluble fertiliser which is supported by the perforated plate (21). It shall be noted that the perforations are configured in a way so that only fertiliser solution can flow to the lower compartment through the perforations but not undissolved fertiliser. Though the term “perforated plate” is used, it does not limit the configuration of the perforated plate (21) to only solid piece of article with appropriately sized holes. Membrane with an appropriate porosity or any other means of the similar function can also be used. As per the foregoing description, it is important to carefully configure the orifice (22) so that water is allowed to flow through, in a controlled manner. Optionally, the upper compartment may comprise a plurality of baffles (not shown) dividing the upper into a number of portions of a desired size capable of holding a desired amount of fertiliser, so that when two or more types of fertiliser are used, the amount of each type of fertiliser can be accurately measured and dosed. Apart from using baffles, other similar means that allow accurate dosing of the fertiliser in the upper compartment can also be used.

The third chamber (3) has a perforated bottom (31) which allows overflow fertiliser solution from the second chamber (2) to pass through and be released to the surrounding medium. It shall be noted that the perforations are configured in a way so that only fertiliser solution can pass through the perforations and prevent foreign solid particles from the surrounding medium from entering the container. The perforated bottom (31) can be any means of similar function, such as, but is not limited to, a solid bottom with appropriately size holes, a wire mesh, or a membrane with an appropriate porosity.

As described by the preferred embodiment of the invention, the orifice (12, 22) of the first (1) and second chambers (2) are configured to control liquid flow rate according to the formula Q=C_{d}A\sqrt{2gh}, wherein Q refers to the liquid flow rate through the orifice (12, 22), C_{d} refers to coefficient of discharge, A refers to the effective surface area of the orifice (12, 22), g refers to gravitational force, and h refers to the height of liquid in the chambers (1, 2). C_{d} varies according to the profile of the orifice (12, 22), which mainly includes its height, cross-sectional shape, and size. C_{d} of an orifice (12, 22) can be obtained in the literature or calculated through any available programme in the art. Preferably, the cross section of the orifices (12, 22) is trapezoidal, circular, square, or rectangular, in which the C_{d} and liquid flow pattern thereof are well-recorded in the literature. The effective surface area (A) of the orifice (12, 22) refers to the smallest surface area of the orifice (12, 22) where the liquid can pass through. According to the formula, the liquid flow rate through an orifice (12, 22) can be controlled at a desired flow rate by varying the orifice (12, 22) profile, effective surface area (A) of the orifice (12, 22), as well as the liquid height in the chambers (1, 2). It is hard to ensure a constant liquid height in the first chamber (1) at all time unless an automatic irrigation system is installed or periodic manual irrigation is carried out, either of which is costly. Hence, the liquid flow rate through the orifice (12) of the first chamber (1) can only be controlled at a range of workable flow rate instead of a single value of desired flow rate. Accordingly, the amount of fertiliser solution collected at the lower compartment of the second chamber (2) also varies and therefore the liquid flow rate through the orifice (22) of the second chamber (2) also varies. Therefore, emphasis may be put on careful configuration of the orifice profile (12, 22) in order to maintain a workable range of liquid flow rate at least at most of the time. The foregoing workable or desired range of liquid flow rate is dependent on the type and condition of plant species, rainfall, soil condition, or any other determining factor.

Preferably, the height of the lower compartment of the second chamber (2) is greater than the height of the first chamber (1). This is to ensure that there is sufficient buffering space for the fertiliser solution in the second chamber (2) before flowing to the third chamber (3).

The foregoing description focuses on the container as a one-piece article having the three chambers (1, 2, 3) formed integrally. Such configuration may not be optimal as the container is not reusable. Upon depletion of the fertiliser, a replacement with a new container containing pre-filled fertiliser is needed. Hence, it is advantageous to form the container from detachable and stacking chambers (1, 2, 3). In accordance to the preferred embodiment of the invention, the container comprises three detachable and stacking units, which are also the first chamber (1), the second chamber (2), and the third chamber (3). Such arrangement also allows a greater flexibility in customising the flow rate of water and/or fertiliser solution. For example, if a change in flow rate of water is desired while maintaining the fertiliser solution flow rate, one may simply replace the first chamber (1) without the need of changing the rest.

Although the first chamber (1) and the second chamber (2) as described only comprise one orifice (12, 22) in each chamber, it shall not be limited thereto, and a number of more than one orifice can be provided in each chamber. However, one orifice is preferred as it is easier to predict and control the flow rate and pattern through each orifice.

When in use, the container is partially embedded in ground so that collection of water through the top of the first chamber (1) is not obstructed. Preferably, the first chamber (1) is above ground while the rest is in ground. In order to maintain the position of the container, it is preferable to provide the container with an anchoring means. The mechanism and configuration of anchoring an object in ground is well-known in the art and will not be described in details.

Although the invention has been described and illustrated in detail, it is to be understood that the same is by the way of illustration and example, and is not to be taken by way of limitation. The spirit and scope of the present invention are to be limited only by the terms of the appended claims.

1. A container for controlling release of a soluble fertiliser comprising:
a first chamber for collecting and holding water, and having an open top and a solid bottom with an orifice that allows water flow freely at a desired rate;
a second chamber below the first chamber for receiving water therefrom to dissolve fertiliser held therein, the second chamber having a solid bottom with an orifice through which fertiliser solution can flow in a controlled manner and a perforated plate for holding undissolved fertiliser, the plate is disposed within the chamber and separating the chamber into an upper compartment: and
a lower compartment; and
a third chamber below the second chamber and receiving dissolved fertiliser therefrom, the third chamber having a perforated bottom, the perforations are configured to allow the dissolved fertiliser to pass through while preventing foreign solid particles from entering the container.

2. A container according to claim 1, wherein the chambers are detachable and stacking one on top of the other.

3. A container according to claim 1 further comprising a perforated cover over the first chamber to prevent foreign solid particles from entering the container while allowing water to pass through.

4. A container according to claim 1, wherein the flow rate through the orifices is configured according to the formula Q=C_{d}A,\sqrt{2gh}, in which Q is liquid flow rate through the orifice C_{d} is coefficient of discharge, A is effective surface area of the orifice, g is gravitational force, and h is height of the liquid in the chamber.

5. A container according to claim 1, wherein the cross-section of the orifices is trapezoidal, circular, square, or rectangular.

6. A container according to claim 1, further comprising a means for anchoring the container in ground.
